(19) United States
(12) Patent Application Publication
(10) Pub. No.: US 2020/0037316 A1
(43) Pub. Date: Jan. 30, 2020

(54) SEMI-PERSISTENT SCHEDULING METHOD AND USER TERMINAL

(71) Applicant: NTT DOCOMO, INC., Tokyo (JP)

(72) Inventors: Huan WANG, Beijing (CN); Qun ZHAO, Beijing (CN); Xiaolin HOU, Beijing (CN); Huiling JIANG, Beijing (CN)

(73) Assignee: NTT DOCOMO, INC., Tokyo (JP)

(21) Appl. No.: 16/497,713

(22) PCT Filed: Mar. 30, 2018
(86) PCT No.: PCT/CN2018/081209

§ 371 Date: Sep. 25, 2019

(30) Foreign Application Priority Data
Apr. 6, 2017 (CN) 201710221873.9

(51) Int. Cl. H04W 72/04; H04W 72/12; H04W 24/10

(52) U.S. Cl. CPC H04W 72/0446; H04W 72/042; H04W 24/10; H04W 72/1221

(57) ABSTRACT

A semi-persistent scheduling (SPS) method and a user terminal is presented. The semi-persistent scheduling (SPS) method within a resource reserving time period includes: determining resource occupancy locations for SPS processes according to a data arrival time and a time offset, wherein the resource reserving time period includes one or more time intervals, and there are a plurality of SPS processes in each time interval; and transmitting data by using at least a part of the plurality of SPS processes.

### TECHNICAL FIELD

The present invention relates to a field of wireless communications, and in particular to a semi-persistent scheduling method and a user terminal that may be used in a wireless communication system.

### BACKGROUND

Device to device (D2D) communication has become an important technology used in 4G and 5G communication systems. In addition to a conventional Uu interface for uplink and downlink transmission between a user terminal and a base station, a PC5 interface is also proposed in the communication systems in order to support the D2D communication. The PC5 interface may have a plurality of modes according to different application scenarios, for example, a mode 3 for UEs within range, and a mode 4 for UEs within a range and not in the range.

On the other hand, in the device to device communication technology, a semi-persistent scheduling (SPS) for periodically configuring resources used by a specific terminal device is proposed. Since resources allocated in one SPS may be used periodically (that is, may be used multiple times), it is not necessary to transmit downlink control information (DCI) for the UE in each transmission time interval (TTI), thereby reducing overhead of control signaling.

However, in the semi-persistent scheduling (SPS) method, the UE performs communication by using a half-duplex mode. That is, the UE cannot transmit while receiving data. That is, when one UE transmits data, it cannot receive data transmitted by another UE to it. In the case of communicating among a group of user terminals, each user terminal needs to know the data transmitted by other user terminals in a user group to which it belongs. However, since the communication is carried out in the half-duplex manner in the semi-persistent scheduling, the UE may miss the data transmitted by the other UEs in the user group to which it belongs, which leads the UE to be unable to carry out corresponding processing according to the data transmitted by the other UEs. In addition, similar problems exist when one UE communicates with another specific user by using the SPS method.

In addition, the resources required for transmitting data are periodically reserved in the existing semi-persistent scheduling method. Thus, when the UE misses the data transmitted by another UE to it because it transmits data during one transmission period, it means that the UE will still use the same resources to transmit data during a next transmission period, and will continue to miss the data transmitted by the another UE to it during the next transmission period.

### SUMMARY OF THE INVENTION

According to one aspect of the present invention, a semi-persistent scheduling (SPS) method within a resource reserving time period is provided, including: determining resource occupancy locations for SPS processes according to a data arrival time and a time offset, wherein the resource reserving time period includes one or more time intervals, and there are a plurality of SPS processes in each time interval; transmitting data by using at least a part of the plurality of SPS processes.

According to another aspect of the present invention, a semi-persistent scheduling (SPS) method performed by a first user terminal is provided, including: detecting transmission resources used by other user terminals in a monitoring window, comprising: detecting transmission resources used by other user terminals in a monitoring window; carrying out a resource selection in a first manner according to transmission resources used by a user terminal in a same user group as the first user terminal; carrying out a resource selection in a second manner according to transmission resources used by a user terminal that is not in a same user group as the first user terminal; carrying out the semi-persistent scheduling by using the selected resources.

According to another aspect of the present invention, a user terminal is provided, including: a determining unit configured to determine resource occupancy locations for SPS processes according to a data arrival time and a time offset, wherein the resource reserving time period includes one or more time interval, and there are a plurality of SPS processes in each time interval; a transmitting unit configured to transmit data using at least a part of the plurality of SPS processes.

According to another aspect of the present invention, a user terminal is provided, including: a monitoring unit configured to detect transmission resources used by other user terminals in a monitoring window; a selecting unit configured to carry out a resource selection in a first manner according to transmission resources used by a user terminal in a same user group as the first user terminal, and carry out a resource selection in a second manner according to transmission resources used by a user terminal that is not in a same user group as the first user terminal; and a transmitting unit configured to carry out the semi-persistent scheduling by using the selected resources.

With the semi-persistent scheduling method and the user terminal according to the above aspects of the present invention, it is possible to effectively reduce the possibility that, when carrying out communication in the half-duplex manner, the UE misses the data transmitted by the other users because it cannot receive data while transmitting.

### BRIEF DESCRIPTION OF THE DRAWINGS

The above and other objects, features and advantages of the present invention will become clearer by describing embodiments of the present invention in details with reference to the accompanying drawings.

FIG. 1A shows a schematic diagram of one scenario in which a SPS method is applied, and FIG. 1B shows a schematic diagram of another scenario in which the SPS method is applied.

FIG. 2 shows a flow chart of a SPS method within a resource reserving time period according to one embodiment of the present invention.

FIG. 3 is a schematic diagram showing that resource occupancy locations for SPS processes are determined according to a data arrival time and a time offset in one time interval according to one example of the present invention.

FIG. 4 is a schematic diagram showing that a plurality of time intervals are included in a resource reserving time period according to one example of the present invention.

FIG. 5 shows a flow chart of a SPS method performed by a first user terminal according to one embodiment of the present invention.

FIG. 6 is a schematic diagram showing that resources for SPS processes are selected according to one example of the present invention.

FIG. 7 is a block diagram showing a user terminal according to one embodiment of the present invention.

FIG. 8 is a block diagram showing a user terminal according to one embodiment of the present invention.

FIG. 9 is a diagram showing one example of a hardware structure of a user terminal involved in one implementation of the present invention.

### DESCRIPTION OF THE EMBODIMENTS

A scheduling method, a base station, and a mobile station according to embodiments of the present invention will be described below with reference to the accompanying drawings. Like reference numerals refer to like elements throughout the accompanying drawings. It should be understood that the embodiments described herein are merely illustrative and should not be constructed as limiting the scope of the present invention. In addition, the UE described herein may include various types of user terminals, for example, a mobile terminal (or referred to as a mobile station) or a fixed terminal. However, for convenience, the UE and the mobile station sometimes may be used interchangeably hereinafter.

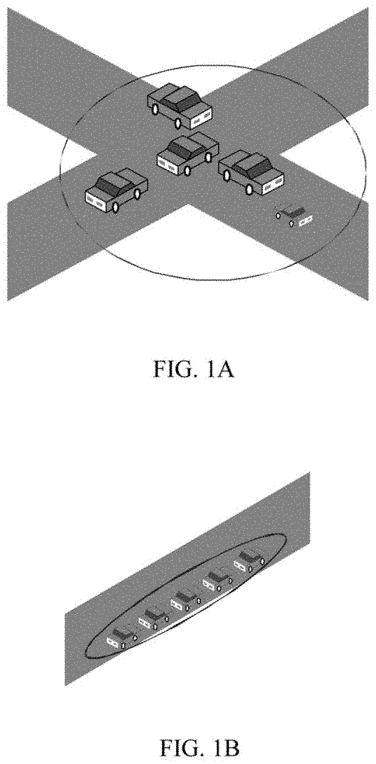

Hereinafter, an exemplary scenario in which a SPS method is applied will be described with reference to FIG. 1A and FIG. 1B. FIG. 1A is a schematic diagram showing one scenario in which the SPS method is applied. FIG. 1B is a schematic diagram showing another scenario in which the SPS method is applied. As shown in FIG. 1A and FIG. 1B, device to device communication may be applied between respective vehicles in a vehicle network. Specifically, in an example shown in FIG. 1A, when driving automatically, one vehicle may obtain positions of other vehicles in its vicinity through the device to device communication to avoid collision with other vehicles. In addition, in an example shown in FIG. 1B, when a plurality of vehicles are traveling together, one vehicle may obtain positions of other vehicles in a fleet to which it belongs through the device to device communication to follow the fleet to travel.

However, when data is transmitted between respective devices with existing SPS methods, a terminal device such as a vehicle cannot transmit while receiving data, which causes that one vehicle may be unable to receive data such as location information transmitted by other vehicles, and thus unable to carry out a corresponding avoidance or follow-up operation.

The embodiments of the present invention improve the SPS methods and the user terminal. Hereinafter, the embodiments of the present invention will be described with reference to the accompanying drawings.

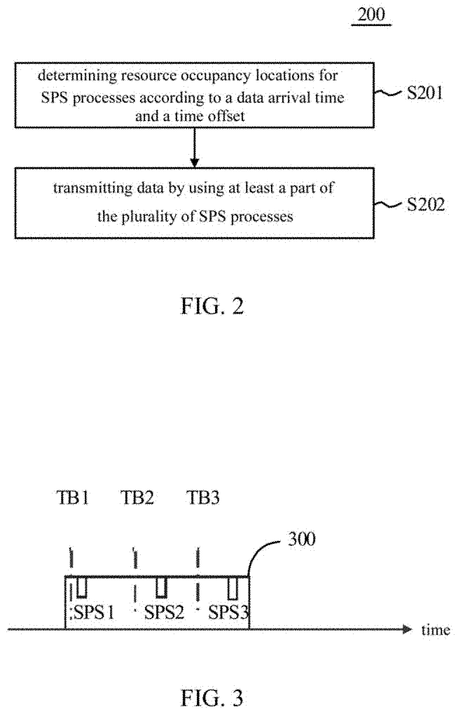

Hereinafter, a semi-persistent scheduling (SPS) method during a resource reserving time period according to one embodiment of the present invention will be described with reference to FIG. 2. FIG. 2 shows a flow chart of a SPS method 200 during a resource reserving time period according to one embodiment of the present invention. In the embodiments according to the present invention, a length of a time interval may be preset.

As shown in FIG. 2, in step S201, resource occupancy locations for SPS processes are determined according to a data arrival time and a time offset, where there are a plurality of SPS processes in each time interval. According to one example of the present invention, the data may arrive periodically. In this case, the data arrival time may include a data arrival period. According to another example of the present invention, the time offset may be randomly determined by the UE when carrying out a resource selection. Alternatively, the time offset may also be allocated to the UE by the base station when carrying out a resource allocation. In addition, the time offset may be a randomly selected time offset within a predetermined range.

FIG. 3 is a schematic diagram showing that the resource occupancy locations for SPS processes are determined according to the data arrival time and the time offset in one time interval according to one example of the present invention. In an example shown in FIG. 3, arrival periods of three data blocks (transport block, TB, in this example) TB1, TB2, and TB3 are included in a time interval 300. The time offset may be carried out on the basis of the data arrival times of TB1, TB2, and TB3, thereby determining the SPS processes corresponding to the data arrival times of TB1, TB2, and TB3, that is, the resource occupancy locations for SPS1, SPS2, and SPS3, respectively. According to another example of the present invention, the time offset of each TB may be randomly determined when the UE carries out the resource selection. For example, for TB1, TB2, and TB3, the UE may carry out a mode 4 resource selection in a sidelink for three times to establish SPS1, SPS2, and SPS3, respectively.

Returning to FIG. 2, according to another example of the present invention, the method of FIG. 2 may also include obtaining the number of SPS processes in one time interval. For example, the number of SPS processes in one time interval may be preset. For another example, a maximum number of SPS processes in one time interval may be preset. The number of SPS processes in one time interval is then determined within a range of the maximum number of SPS processes.

The number of SPS processes in one time interval or the maximum number of SPS processes in one time interval may be set for respective UEs. In addition, the number of SPS processes in one time interval or the maximum number of SPS processes in one time interval that is applicable to a cell may also be set for the cell. In addition, the number of SPS processes in one time interval or the maximum number of SPS processes in one time interval that is applicable to a service type may also be set for the service type.

In addition, according to another example of the present invention, the method of FIG. 2 may also include determining the length of the time interval. For example, the method shown in FIG. 2 further includes determining the length of the time interval according to a data transmission period of the data that the user terminal needs to transmit, and the obtained number of SPS processes in one time interval. For example, the data transmission period is 100 ms. In a case where it is determined that the number of SPS processes of the UE in one time interval is 5, the length of the time interval may be determined to be 500 ms.

In addition, according to another example of the present invention, a resource occupancy period of one SPS process is the length of one time interval. In a case that the resource reserving time period includes a plurality of time intervals, the method shown in FIG. 2 may further include determining resources occupied by the SPS process in a second time interval after a first time interval, according to the determined resource occupancy locations and the resource occupancy period of the SPS process in the first time interval. That is, in a case where the SPS includes a plurality of time intervals in the resource reserving time period, a pattern of the resource occupancy locations for the SPS process determined in the first time interval may be repeated in subsequent time intervals.

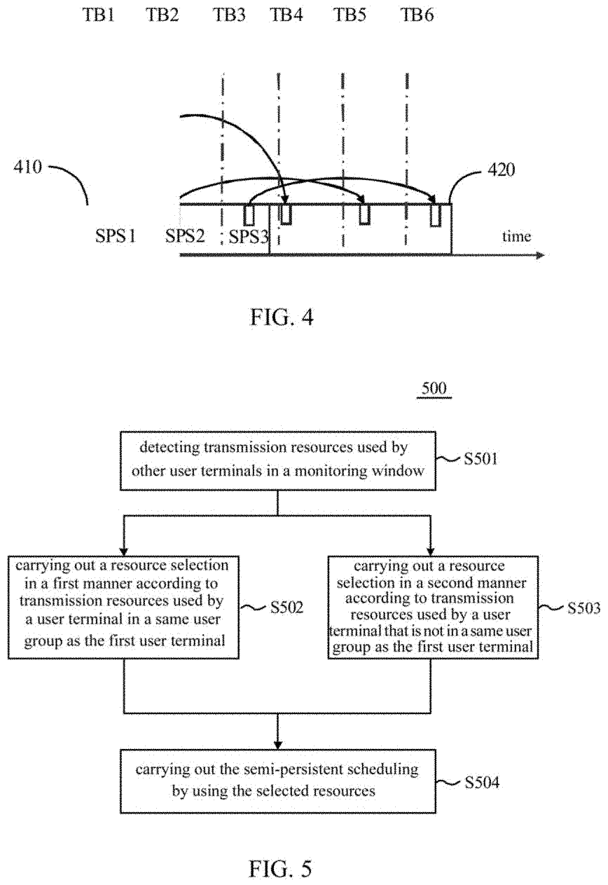

FIG. 4 is a schematic diagram showing that a plurality of time intervals are included in a resource reserving time period according to one example of the present invention. As shown in FIG. 4, the resource reserving time period includes a first time interval 410 and a second time interval 420. Similar to the time interval 300 shown in FIG. 3, the arrival periods of three data blocks (transport block, TB, in this example) TB1, TB2, and TB3 are included in the first time interval 410. The time offset may be carried out on the basis of the data arrival times of TB1, TB2, and TB3, thereby determining the SPS processes corresponding to the data arrival times of TB1, TB2, and TB3, that is, the resource occupancy locations for SPS1, SPS2, and SPS3, respectively. In addition, the resource occupancy periods of SPS1, SPS2, and SPS3 are the length of one time interval, and as shown by the arrows in FIG. 4, the resources occupied by SPS1, SPS2, and SPS3 in the second time interval may be determined according to the resource occupancy locations for SPS1, SPS2, and SPS3 and the resource occupancy periods of SPS1, SPS2, and SPS3 in the first time interval, respectively. That is, the pattern of the resource occupancy locations for the SPS processes determined in the first time interval 410 is repeated in the second time interval 420.

Returning to FIG. 2, in step S202, data is transmitted by using at least a part of the plurality of SPS processes. According to one example of the present invention, in one time interval, at least a part of the plurality of SPS processes present in the time interval may be established or released, respectively. For example, each of the plurality of SPS processes present in the time interval may be established or released one by one.

In the semi-persistent scheduling method according to the present embodiment, by determining the resource occupancy locations for the SPS processes by time-offsetting the data arrival time and setting a plurality of SPS processes in one time interval, it is possible to effectively reduce the possibility that, when carrying out communication in the half-duplex manner, the UE misses the data transmitted by the other users because it cannot receive data while transmitting, and to improve a spectrum efficiency.

Hereinafter, a semi-persistent scheduling (SPS) method performed by a first user terminal according to another embodiment of the present invention will be described with reference to FIG. 5. FIG. 5 shows a flow chart of a SPS method 500 performed by the first user terminal according to one embodiment of the present invention.

As shown in FIG. 5, in step S501, transmission resources used by other user terminals are detected in a monitoring window. Then, in step S502, a resource selection is carried out in a first manner according to transmission resources used by a user terminal in a same user group as the first user terminal; and in step S503, a resource selection is carried out in a second manner according to transmission resources used by a user terminal that is not in a same user group as the first user terminal. It should be noted that although in the example shown in FIG. 5, step S502 and step S503 are shown in a parallel order, step S502 may be performed and then step S503 may be performed, and vice versa, for example.

According to one example of the present invention, in step S502, when carrying out the resource selection, resources corresponding to subframes to which the transmission resources used by the user terminal in the same user group as the first user terminal belong are excluded. In addition, in step S503, when carrying out the resource selection, it may only exclude resources of the transmission resources used by the user terminal that are not in the same user group as the first user terminal, instead of the entire subframe to which the resources belong.

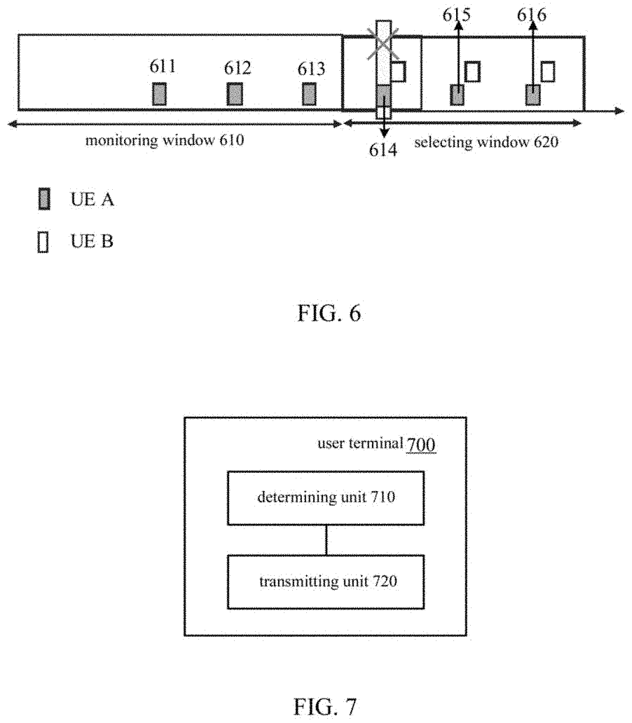

FIG. 6 is a schematic diagram showing that resources for SPS processes are selected according to one example of the present invention. As shown in FIG. 6, in the monitoring window 610, UE A detects transmission resources used by other user terminals. In an example shown in FIG. 6, transmission resources used by UE B, that is, resource blocks 611, 612, and 613 are detected in the monitoring window 610. In the SPS method, the UE periodically uses transmission resources. Therefore, the resources used by UE B after the monitoring window 610 may be determined according to the transmission resources used by UE B and the resource usage period detected in the monitoring window 610. For example, as shown in FIG. 6, it may be determined that the resources used by UE B in a selection window following the monitoring window 610 are resource blocks 614, 615 and 616.

UE A may carry out resource selection in the selection window 620 according to whether UE B is in a same user group as UE A. When UE B and UE A are in the same user group, UE A may exclude resources corresponding to the subframes to which the transmission resources used by UE B belong. For example, as shown in FIG. 6, for the resource block 614, UE A excludes resources corresponding to the entire subframe to which the resource block 614 belongs. Thereby, it is avoided that UE A also may carry out data transmission in the subframe in which UE B may carry out data transmission, and cannot receive the data transmitted by UE B. On the other hand, when UE B and UE A are not in the same user group, UE A may not care about the data transmitted by UE B. Thus, UE A may only exclude the transmission resources used by UE B (the resource blocks used by UE B).

The above description is made by taking an example in which the resources corresponding to the subframes in which the transmission resources used by the user terminals in the same user group as the first user terminal are excluded in step S502. However, the resource selection method of the present invention is not limited thereto. Alternatively, in step S502, when carrying out the resource selection, resources different from resources corresponding to the subframes to which the transmission resources used by the user terminals in the same user group as the first user terminal belong are preferentially selected. That is, in step S502, when carrying out the resource selection, the priority of the resources corresponding to the subframes to which the transmission resources used by the other user terminals belong may be reduced, instead of excluding the resources corresponding to the subframes. For example, when the user terminal does not have available transmission resources in subframes other than the subframes to which the transmission resources used by other user terminals belong, the resources in the subframes to which the transmission resources used by other user terminals belong may still be used.

In addition, according to another example of the present invention, the method shown in FIG. 5 may further include determining whether the user terminal and the first user terminal are in the same user group according to a user identifier or a group identifier transmitted by other user terminals detected in the monitoring window.

Then, as shown in FIG. 5, in step S504, the semi-persistent scheduling is carried out by using the selected resources.

In the semi-persistent scheduling method according to the present embodiment, the first user terminal can select the SPS process resources used by the terminal in different manners, based on the transmission resources used by the user terminals in the same user group as the terminal and the transmission resources used by the user terminals not in the same user group as the terminal. It is possible to effectively reduce the possibility that, when carrying out communication in the half-duplex manner, the UE misses the data transmitted by the other users because it cannot receive data while transmitting, and to improve the spectrum efficiency.

Next, a user terminal according to one embodiment of the present invention will be described with reference to FIG. 7. FIG. 7 is a block diagram showing a user terminal 700 according to one embodiment of the present invention. As shown in FIG. 7, the user terminal 700 includes a determining unit 710 and a transmitting unit 720. The user terminal 700 may include other components in addition to these two units, however, since these components are not related to the content of the embodiments of the present invention, the illustration and description thereof are omitted herein. In addition, since the specific details of the operations described below performed by the user terminal 700 according to the embodiments of the present invention are the same as those described above with reference to FIGS. 1-4, repeated description of the same details is omitted herein to avoid repetition.

As shown in FIG. 7, the determining unit 710 may determine resource occupancy locations for SPS processes according to a data arrival time and a time offset, where there are a plurality of SPS processes in each time interval. According to one example of the present invention, the data may arrive periodically. In this case, the data arrival time may include a data arrival period. According to another example of the present invention, the time offset may be randomly determined by the UE when carrying out a resource selection. Alternatively, the time offset may also be allocated to the UE by the base station when carrying out a resource allocation. In addition, the determining unit 710 may randomly select the time offset within a predetermined range.

According to another example of the present invention, the user terminal 700 may further include an acquiring unit to obtain the number of the SPS processes in one time interval. For example, the number of SPS processes in one time interval may be preset. For another example, a maximum number of SPS processes in one time interval may be preset. The number of SPS processes in one time interval is then determined within a range of the maximum number of SPS processes. In this case, the user terminal 700 may further include a storage unit to store the preset number of SPS processes in one time interval, or the preset maximum number of SPS processes in one time interval.

The number of SPS processes in one time interval or the maximum number of SPS processes in one time interval may be set. In addition, the number of SPS processes in one time interval or the maximum number of SPS processes in one time interval that is applicable to a cell may also be set for the cell. In addition, the number of SPS processes in one time interval or the maximum number of SPS processes in one time interval that is applicable to a service type may also be set for the service type.

In addition, according to another example of the present invention, the determining unit 710 may also determine the length of the time interval. For example, the method shown in FIG. 2 further includes determining the length of the time interval according to a transmission period of the data that the user terminal needs to transmit, and the obtained number of SPS processes in one time interval. For example, the data transmission period is 100 ms. In a case where it is determined that the number of SPS processes of the UE in one time interval is 5, the length of the time interval may be determined to be 500 ms.

In addition, according to another example of the present invention, a resource occupancy period of one SPS process is the length of one time interval. In a case that the resource reserving time period includes a plurality of time intervals, the method shown in FIG. 2 may further include determining resources occupied by the SPS process in a second time interval after a first time interval, according to the determined resource occupancy locations and the resource occupancy period of the SPS process in the first time interval. That is, in a case where the SPS includes a plurality of time intervals in the resource reserving time period, a pattern of the resource occupancy locations for the SPS process determined in the first time interval may be repeated in subsequent time intervals.

The transmitting unit 720 may transmit data by using at least a part of the plurality of SPS processes. According to one example of the present invention, in one time interval, the determining unit may also establish, trigger or release at least a part of the plurality of SPS processes present in the time interval, respectively. For example, each of the plurality of SPS processes present in the time interval may be established or released one by one.

In the terminal device according to the present embodiment, by determining the resource occupancy locations for the SPS processes by time-offsetting the data arrival time and setting a plurality of SPS processes in one time interval, it is possible to effectively reduce the possibility that, when carrying out communication in the half-duplex manner, the UE misses the data transmitted by the other users because it cannot receive data while transmitting. A spectrum efficiency may be improved.

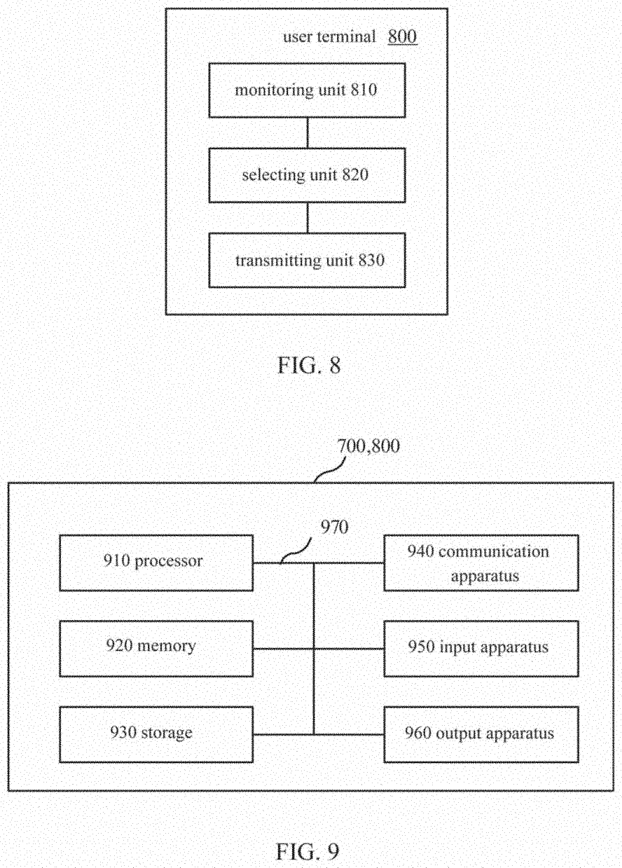

Next, a user terminal according to another embodiment of the present invention will be described with reference to FIG.8. FIG. 8 is a block diagram showing a user terminal 800 according to one embodiment of the present invention. As shown in FIG. 8, the user terminal 800 includes a monitoring unit 810, a selecting unit 820, and a transmitting unit 830. The user terminal 800 may include other components in addition to these three units, however, since these components are not related to the content of the embodiments of the present invention, the illustration and description thereof are omitted herein. In addition, since the specific details of the operations described below performed by the user terminal 800 according to the embodiments of the present invention are the same as those described above with reference to FIGS. 5-6, repeated description of the same details is omitted herein to avoid repetition.

As shown in FIG. 8, the monitoring unit 810 detects transmission resources used by other user terminals in a monitoring window. Then, the selecting unit 820 carries out a resource selection in a first manner according to transmission resources used by a user terminal in a same user group as the first user terminal; and the selecting unit 820 further carries out a resource selection in a second manner according to transmission resources used by a user terminal that is not in a same user group as the first user terminal.

According to one example of the present invention, when carrying out the resource selection, the selecting unit 820 excludes resources corresponding to subframes to which the transmission resources used by the user terminal in the same user group as the first user terminal belong. In addition, when carrying out the resource selection, the selecting unit 820 may only exclude resources of the transmission resources used by the user terminal that are not in the same user group as the first user terminal, instead of the entire subframe to which the resources belong.

The above description is made by taking an example in which the resources corresponding to the subframes in which the transmission resources used by the user terminals in the same user group as the first user terminal are excluded by the selecting unit 820. However, the resource selection method of the present invention is not limited thereto. Alternatively, when carrying out the resource selection, the selecting unit 820 may preferentially select resources different from resources corresponding to the subframes to which the transmission resources used by the user terminals in the same user group as the first user terminal belong. That is, when carrying out the resource selection, the selecting unit 820 may reduce the priority of the resources corresponding to the subframes to which the transmission resources used by the other user terminals belong, instead of excluding the resources corresponding to the subframes. For example, when the user terminal does not have available transmission resources in subframes other than the subframes to which the transmission resources used by other user terminals belong, the selecting unit 820 may still use the resources in the subframes to which the transmission resources used by other user terminals belong.

In addition, according to another example of the present invention, the selecting unit 820 may further include determining whether the user terminal and the first user terminal are in the same user group according to a user identifier or a group identifier transmitted by other user terminals detected in the monitoring window.

Then, the transmitting unit 830 may carry out the semi-persistent scheduling by using the resources selected by the selecting unit 820.

In the terminal according to the present embodiment, the terminal can select the SPS process resources used by the terminal in different manners, based on the transmission resources used by the user terminals in the same user group as the terminal and the transmission resources used by the user terminals not in the same user group as the terminal. It is possible to effectively reduce the possibility that, when carrying out communication in the half-duplex manner, the UE misses the data transmitted by the other users because it cannot receive data while transmitting, and to improve the spectrum efficiency.

<Hardware Structure>

It should be noted that block diagrams used for the illustration of the above embodiments represent functional blocks in functional units. These functional blocks (components) are realized by any combination of hardware and/or software. In addition, the means for implementing respective function blocks is not particularly limited. That is, respective functional blocks may be realized by one apparatus that is physically and/or logically aggregated, or may be realized by directly and/or indirectly (for example, wired and/or wireless) connecting two or more physically and/or logically separate apparatuses and using the plurality of apparatuses.

For example, the radio base station, user terminals and so on in one embodiment of the present invention may function as a computer that executes the processes of the radio communication method of the present invention. FIG. 9 is a diagram that shows an example of a hardware structure of the user terminal according to one implementation of the present invention. The above described user terminals 700 and 800 may be physically designed as a computer apparatus including a processor 910, a storage 920, a memory 930, a communication apparatus 940, an input apparatus 950, an output apparatus 960, and a bus 970 and the like.

It should be noted that, in the following description, the word “apparatus” may be replaced by “circuit”, “device”, “unit” and so on. It should be noted that the hardware structure of user terminals 700 and 800 may be designed to include one or more of each apparatus shown in the drawings, or may be designed not to include part of the apparatus.

For example, although only one processor 910 is shown, a plurality of processors may be provided. Furthermore, processes may be implemented with one processor, or processes may be implemented either simultaneously or in sequence, or in different manners, on two or more processors. It should be noted that the processor 910 may be implemented with one or more chips.

Each function of the user terminals 700 and 800 is implemented by reading predetermined software (program) on hardware such as the processor 910 and the memory 920, so as to make the processor 910 perform calculations, and by controlling the communication carried out by the communication apparatus 940, and the reading and/or writing of data in the memory 920 and the storage 930.

The processor 910 may control the whole computer by, for example, running an operating system. The processor 910 may be configured with a central processing unit (CPU), which includes interfaces with peripheral apparatus, control apparatus, computing apparatus, a register and so on. For example, the baseband signal processing unit 104 (204), the call processing unit 105, and the like described above may be implemented by the processor 910.

Furthermore, the processor 910 reads programs (program codes), software modules or data, from the storage 930 and/or the communication apparatus 940, into the memory 920, and executes various processes according to these. As for the programs, programs to allow computers to execute at least part of the operations of the above-described embodiments may be used. For example, the determining unit 710 of the user terminal 700 may be implemented by a control program stored in the memory 920 and operated by the processor 910. For another example, the selecting unit 820 of the user terminal 800 may be implemented by a control program stored in the memory 920 and operated by the processor 910. For other function blocks, they can also be implemented in the same way.

The memory 920 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 920 may be referred to as a “register”, a “cache”, a “main memory” (primary storage apparatus) and so on. The memory 920 can store executable programs (program codes), software modules and so on for implementing the radio communication methods according to embodiments of the present invention.

The storage 930 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 930 may be referred to as “secondary storage apparatus.”

The communication apparatus 940 is hardware (transmitting/receiving device) for allowing inter-computer communication by using wired and/or wireless networks, and may be referred to as, for example, a “network device”, a “network controller”, a “network card”, a “communication module” and so on. The communication apparatus 940 may include, but is not limited to, a high frequency switch, a filter, a frequency synthesizer, and the like. For example, the above-described transmitting units 720, 830 and the like may be implemented by the communication apparatus 940.

The input apparatus 950 is an input device for receiving input from the outside (for example, a keyboard, a mouse, a microphone, a switch, a button, a sensor and so on). The output apparatus 960 is an output device for allowing sending output to the outside (for example, a display, a speaker, an LED (Light Emitting Diode) lamp and so on). It should be noted that the input apparatus 950 and the output apparatus 960 may be provided in an integrated structure (for example, a touch panel).

Furthermore, these pieces of apparatus, including the processor 910, the memory 920 and so on are connected by the bus 970 so as to communicate information. The bus 970 may be formed with a single bus, or may be formed with buses that vary between pieces of apparatus.

Also, the user terminals 700 and 800 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 910 may be installed with at least one of these pieces of hardware.

(Variations)

It should be noted that the terms illustrated in the present specification and/or the terms required for the understanding of the present specification may be substituted with terms having the same or similar meaning. For example, a channel and/or a symbol may be a signal. In addition, the signal may be a message. A reference signal may be abbreviated as an “RS (Reference Signal)”, and may be referred to as a “pilot”, a “pilot signal” and so on, depending on which standard applies. In addition, a component carrier (CC) may be referred to as a carrier frequency, a cell, or the like.

In addition, the radio frame may be composed of one or more periods (frames) in the time domain. Each of the one or more periods (frames) constituting the radio frame may also be referred to as a subframe. Further, a subframe may be composed of one or more slots in the time domain. The subframe may be a fixed length of time duration (eg, 1 ms) that is independent of the numerology.

Furthermore, a slot may be comprised of one or more symbols in the time domain (OFDM (Orthogonal Frequency Division Multiplexing) symbols, SC-FDMA (Single Carrier Frequency Division Multiple Access) symbols, and so on). Furthermore, the slot may also be a time unit configured based on parameter. Furthermore, a slot may also include a plurality of microslots. Each microslot may be comprised of one or more symbols in the time domain. Furthermore, a microslot may also be referred as “a subframe”.

A radio frame, a subframe, a slot, a microslot and a symbol all represent the time unit when transmitting signals. A radio frame, a subframe, a slot, a microslot and a symbol may also use other names that correspond to each other. For example, one subframe may be referred to as a “transmission time interval (TTI)”, and a plurality of consecutive subframes may also be referred to as a “TTI”, and one slot or one microslot may also be referred to as a “TTI.” That is, a subframe and/or a TTI may be a subframe (1 ms) in existing LTE, may be a shorter period than 1 ms (for example, one to thirteen symbols), or may be a longer period of time than 1 ms. It should be noted that a unit indicating a TTI may also be referred to as a slot, a microslot, or the like instead of a subframe.

Here, a TTI refers to the minimum time unit of scheduling in radio communication, for example. For example, in LTE systems, a radio base station schedules the radio resources (such as the frequency bandwidth and transmission power that can be used in each user terminal) to allocate to each user terminal in TTI units. It should be noted that the definition of TTIs is not limited to this.

TTIs may be channel-coded data packets (transport blocks), code blocks, and/or codeword transmission time units, or may be the unit of processing in scheduling, link adaptation and so on. It should be noted that, when a TTI is given, the time interval (e.g., the number of symbols) actually mapped to the transport block, code block, and/or codeword may also be shorter than the TTI.

It should be noted that, when one slot or one microslot is called a TTI, more than one TTI (i.e., more than one slot or more than one microslot) may also become the scheduled minimum time unit. Furthermore, the number of slots (the number of microslots) constituting the minimum time unit of the scheduling may be controlled.

A TTI having a time duration of 1 ms may be referred to as a “normal TTI” (TTI in LTE Rel. 8 to 12), a “standard TTI”, a “long TTI”, a “normal subframe”, a “standard subframe”, or a “long subframe”, and so on. A TTI that is shorter than a normal TTI may be referred to as a “shortened TTI”, a “short TTI”, a “partial (or fractional) TTI”, a “shortened subframe”, a “short subframe”, a “microslot”, or a “short microslot” and so on.

It should be noted that, a long TTI (eg, a normal TTI, a subframe, etc.) may be replaced with a TTI having a time duration exceeding 1 ms, and a short TTI (eg, a shortened TTI, and so on) may also be replaced with a TTI having a TTI duration shorter than the long TTI and a TTI duration exceeding 1 ms.

A resource block (RB) is the unit of resource allocation in the time domain and the frequency domain, and may include one or a plurality of consecutive subcarriers in the frequency domain. Also, an RB may include one or more symbols in the time domain, and may be one slot, one microslot, one subframe or one TTI duration. One TTI and one subframe each may be comprised of one or more resource blocks, respectively. It should be noted that one or more RBs may also be referred to as a “physical resource block (PRB (Physical RB))”, a “Sub-Carrier Group (SCG)”, a “Resource Element Group (REG)”, a “PRG pair”, an “RB pair” and so on.

Also, a resource block may also be composed of one or more resource elements (RE). For example, one RE can be a radio resource area of a subcarrier and a symbol.

It should be noted that the above-described structures of radio frames, subframes, slots, microslots and symbols and so on are simply examples. For example, configurations such as the number of subframes included in a radio frame, the number of slots of each subframe or radio frame, the number or microslots included in a slot, the number of symbols and RBs included in a slot or microslot, the number of subcarriers included in an RB, the number of symbols in a TTI, the symbol duration and the cyclic prefix (CP) duration can be variously changed.

Also, the information and parameters and so on described in this specification may be represented in absolute values or in relative values with respect to predetermined values, or may be represented in corresponding other information. For example, radio resources may be indicated by predetermined indices. In addition, equations to use these parameters and so on may be used, apart from those explicitly disclosed in this specification.

The names used for parameters and so on in this specification are not limited in any respect. For example, since various channels (PUCCH (Physical Uplink Control Channel), PDCCH (Physical Downlink Control Channel) and so on) and information elements can be identified by any suitable names, the various names assigned to these various channels and information elements are not limited in any respect.

The information, signals and so on described in this specification may be represented by using any one of various different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output from higher layers to lower layers and/or from lower layers to higher layers. Information, signals and so on may be input and/or output via a plurality of network nodes.

The information, signals and so on that are input and/or output may be stored in a specific location (for example, in a memory), or may be managed in a control table. The information, signals and so on that are input and/or output may be overwritten, updated or appended. The information, signals and so on that are output may be deleted. The information, signals and so on that are input may be transmitted to other apparatus.

Reporting of information is by no means limited to the aspects/embodiments described in this specification, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (the master information block (MIB), system information blocks (SIBS) and so on), MAC (Medium Access Control) signaling and so on), and other signals and/or combinations of these.

It should be noted that physical layer signaling may also be referred to as L1/L2 (Layer 1/Layer 2) control information (L1/L2 control signals), L1 control information (L1 control signal) and so on. Also, RRC signaling may be referred to as “RRC messages”, and can be, for example, an RRC connection setup message, RRC connection reconfiguration message, and so on. Also, MAC signaling may be reported using, for example, MAC control elements (MAC CEs).

Software, whether referred to as “software”, “firmware”, “middleware”, “microcode” or “hardware description language”, or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are included in the definition of communication media.

The terms “system” and “network” as used herein are used interchangeably.

A mobile station is also sometimes used by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

The respective aspects/embodiments illustrated in this specification may be used individually or in combinations, which may also be switched and used during execution. The order of processes, sequences, flowcharts and so on of the respective aspects/embodiments described in the present specification may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to systems that use LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark) and other adequate radio communication methods, and/or next-generation systems that are enhanced based on these.

The phrase “based on” as used in this specification does not mean “based only on”, unless otherwise specified. In other words, the phrase “based on” means both “based only on” and “based at least on.”

Any reference to elements with designations such as “first”, “second” and so on as used herein does not generally limit the number/quantity or order of these elements. These designations are used only for convenience, as a method of distinguishing between two or more elements. In this way, reference to the first and second elements does not imply that only two elements may be employed, or that the first element must precede the second element in some way.

The terms “judging” and “determining” as used herein may encompass a wide variety of actions. For example, “judging” and “determining” may be interpreted to mean making judgements and determinations related to calculating, computing, processing, deriving, investigating, looking up (for example, searching a table, a database or some other data structure), ascertaining and so on. Furthermore, “judging” and “determining” may be interpreted to mean making judgements and determinations related to receiving (for example, receiving information), transmitting (for example, transmitting information), inputting, outputting, accessing (for example, accessing data in a memory) and so on. In addition, “judging” and “determining” as used herein may be interpreted to mean making judgements and determinations related to resolving, selecting, choosing, establishing, comparing and so on. In other words, “judging” and “determining” may be interpreted to mean making judgements and determinations related to some action.

As used herein, the terms “connected” and “coupled”, or any variation of these terms, mean all direct or indirect connections or coupling between two or more elements, and may include the presence of one or more intermediate elements between two elements that are “connected” or “coupled” to each other. The coupling or connection between the elements may be physical, logical or a combination of these. For example, “connection” may be interpreted as “access.” As used herein, two elements may be considered “connected” or “coupled” to each other by using one or more electrical wires, cables and/or printed electrical connections, and, as a number of non-limiting and non-inclusive examples, by using electromagnetic energy, such as electromagnetic energy having wavelengths in radio frequency fields, microwave regions and optical (both visible and invisible) regions.

When terms such as “including”, “comprising” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

1. A semi-persistent scheduling (SPS) method within a resource reserving time period, including:
determining resource occupancy locations for SPS processes according to a data arrival time and a time offset, wherein the resource reserving time period includes one or more time intervals, and there are a plurality of SPS processes in each time interval;
transmitting data by using at least a part of the plurality of SPS processes.

2. The method of claim 1, wherein
in one time interval, at least a part of the plurality of SPS processes present in the time interval are established or released respectively.

3. The method of claim 1, further including:
obtaining the number of SPS processes in one time interval.

4. The method of claim 3, wherein the obtaining the number of SPS processes in one time interval includes:
presetting a maximum number of SPS processes in one time interval; and
determining the number of SPS processes in one time interval within a range of the maximum number of SPS processes.

5. The method of claim 3, further including:
determining a length of the time interval.

6. The method of claim 5, further including:
determining the length of the time interval according to a data transmission period required by the user terminal needs to transmit and the obtained number of SPS processes in one time interval.

7. The method of claim 1, wherein
a resource occupancy period of one SPS process is a length of one time interval, and
the resource reserving time period includes a plurality of time intervals,
the method further includes:
determining resources occupied by the SPS processes in a second time interval after a first time interval, according to the determined resource occupancy locations and the resource occupancy period of the SPS processes in the first time interval.

8-11. (canceled)

12. A user terminal including:
a determining unit configured to determine resource occupancy locations for SPS processes according to a data arrival time and a time offset, wherein the resource reserving time period includes one or more time intervals, and there are a plurality of SPS processes in each time interval;
a transmitting unit configured to transmit data by using at least a part of the plurality of SPS processes.

13. The user terminal of claim 12, wherein
the determining unit is further configured to establish or release at least a part of the plurality of SPS processes present in the time interval in a time interval, respectively.

14. The user terminal of claim 12, further including:
an acquiring unit configured to obtain the number of SPS processes in one time interval.

15. The user terminal of claim 14, further including:
a storage unit configured to store a maximum number of SPS processes preset in one time interval, wherein
the acquiring unit determines the number of SPS processes in one time interval within a range of the maximum number of SPS processes.

16. The user terminal of claim 14, wherein
the determining unit is further configured to determine a length of the time interval.

17. The user terminal of claim 16, wherein
the determining unit determines the length of the time interval according to a transmission period of data that the user terminal needs to transmit and the obtained number of SPS processes in one time interval.

18. The user terminal of claim 12, wherein
a resource occupancy period of one SPS process is a length of one time interval, and
the resource reserving time period includes a plurality of time intervals,
the determining unit is further configured to determine resources occupied by the SPS processes in a second time interval after a first time interval, according to the determined resource occupancy locations and the resource occupancy period of the SPS processes in the first time interval.

19. A user terminal including:
a monitoring unit configured to detect transmission resources used by other user terminals in a monitoring window;
a selecting unit configured to carry out a resource selection in a first manner according to transmission resources used by a user terminal in a same user group as the first user terminal, and carry out a resource selection in a second manner according to transmission resources used by a user terminal that is not in a same user group as the first user terminal; and
a transmitting unit configured to carry out the semi-persistent scheduling by using the selected resources.

20. The user terminal of claim 19, wherein
when carrying out the resource selection, the selecting unit excludes resources corresponding to subframes to which the transmission resources used by the user terminal in the same user group as the first user terminal belong.

21. The user terminal of claim 19, wherein
when carrying out the resource selection, the selecting unit preferentially selects resources different from resources corresponding to subframes to which the transmission resources used by the user terminal in the same user group as the first user terminal belong.

22. The user terminal of claim 19, wherein
the selecting unit determines whether the user terminal and the first user terminal are in the same user group according to a user identifier or a group identifier transmitted by other user terminals detected in the monitoring window.
